(19) United States
(12) Patent Application Publication
(10) Pub. No.: US 2014/0107862 A1
(43) Pub. Date: Apr. 17, 2014

(54) Device And Method For Operating An Unmanned Underwater Vehicle And Underwater Vehicle Having The Device

(71) Applicant: Torsten Jung, Achim (DE)

(72) Inventor: Torsten Jung, Achim (DE)

(73) Assignee: Atlas Elektronik GMBH, Bremen (DE)

(21) Appl. No.: 14/123,520

(22) PCT Filed: Jul. 9, 2012
(86) PCT No.: PCT/EP2012/063347

§ 371 Date: Dec. 3, 2013

(30) Foreign Application Priority Data
Jul. 16, 2011 (DE) 102011107824.3

(51) Int. Cl. G05D 1/00

(52) U.S. Cl. CPC G05D 1/00
USPC 701/1

(57) ABSTRACT

The invention relates to a device and a method for operating an unmanned underwater vehicle, wherein the underwater vehicle has determining means which determine a usability indicator. A use recommendation for the use of the underwater vehicle in a future mission can be derived or is derived from this usability indicator. The determination of the usability indicator takes place as a function of at least one operating parameter of the underwater vehicle. A decision aid relating to the suitability of the underwater vehicle for a respective purpose of use can be made available for an underwater vehicle, which can be used for different purposes by means of the invention. In addition, the invention relates to an underwater vehicle which has at least the determining means and/or storage means for storing a usability indicator which is determined by means of the device according to the invention.

### CROSS-REFERENCE TO RELATED APPLICATIONS

The present invention is the US national stage under 35 U.S.C. §371 of International Application No. PCT/EP2012/063347, which was filed on Jul. 9, 2012 and which claims the priority of application DE 10 2011 107 824.3 filed on Jul. 16, 2011 the content of which (text, drawings and claims) is incorporated here by reference in its entirety.

### FIELD

The invention relates to a device and a method for operating an unmanned underwater vehicle and an unmanned underwater vehicle having the device or parts of the device.

### BACKGROUND

Unmanned underwater vehicles are known in various embodiments for different intended uses. For example, unmanned underwater vehicles are used for inspecting devices below the water surface or for salvaging and/or detonating underwater mines. An unmanned underwater vehicle in this case can be configured as an underwater vehicle operated by cable (ROV=Remotely Operating Vehicle) or as an autonomous underwater vehicle (AUV=Autonomous Underwater Vehicle). The underwater vehicle is thus either self-controlled or is controlled via a cable, for example a fiber optic cable.

Unmanned underwater vehicles are generally driven by means of electromotive drives which are supplied with electrical power from a battery accommodated on the underwater vehicle. In this case, underwater vehicles which are able to be repeatedly used generally comprise a rechargeable battery, in particular a nickel metal hydride battery (NiMh), whereas underwater vehicles which are used for mine clearance by self-destruction, generally have a non-rechargeable primary lithium battery (LiSO2).

According to the prior art, a plurality of differently configured underwater vehicles can be stored on-board a marine vessel, the underwater vehicles being specifically configured for one respective intended use and only being used for the intended use. As a result, for example, underwater vehicles which are provided for mine clearance by self-destruction are already destroyed on their first use and thus destroyed in a new and/or brand new condition.

### SUMMARY

The object of the invention is to improve the operation of underwater vehicles.

The invention achieves this object by a device according to claim 1, by an underwater vehicle according to claim 8 and by a method according to claim 9.

The invention has recognized that it is advantageous if an unmanned underwater vehicle is provided for different intended uses and/or for different applications. The underwater vehicle is, therefore, able to carry out a plurality of different missions, for example initially a plurality of reconnaissance missions and subsequently a mission in which the destruction of the underwater vehicle is to be anticipated.

Moreover, the invention has recognized that it is advantageous to provide operating personnel, who have to select an underwater vehicle from a plurality of underwater vehicles for a specific mission, with a use recommendation for the use of the underwater vehicle in a future mission. The invention has also recognized that this use recommendation is advantageously able to be made as a function of the condition, in particular the serviced state and state of wear, and/or the usability of the underwater vehicle. The invention therefore determines a usability indicator for the underwater vehicle. The use recommendation can be derived from the usability indicator. The usability indicator indicates the condition and/or the usability of the underwater vehicle. In this case, the usability indicator can be a single value. Alternatively, the usability indicator contains a set of values.

Finally, the invention has recognized that the usability indicator is advantageously determined as a function of at least one operating parameter of the underwater vehicle, and in various embodiments determined from the operating parameter. For example, the operating parameter provides information about usage times and thus the state of wear and/or serviced state of the underwater vehicle. Using the usability indicator, therefore, it is possible to identify, for example, that the underwater vehicle is in a brand new condition and/or has been recently serviced so that it can be deduced therefrom, for example as a use recommendation, that this particular underwater vehicle is best suited for a mission which requires a reliable underwater vehicle and where the underwater vehicle is anticipated to return in an undamaged state.

Operating parameters of the underwater vehicle are, for example, an operating time and/or operating hours and/or a travel time and/or a resting time of the underwater vehicle and/or detected environmental parameters which affect the condition of the underwater vehicle.

In an advantageous embodiment, the usability indicator is a function of data of at least one operating time and/or operating hours of the underwater vehicle which have taken place in at least one previous time period. The operating time is, therefore, the time during which the underwater vehicle is actually operated and/or used for a mission and not simply stored. Specifically, the operating time has a marked influence on the ageing of the underwater vehicle, in particular on the wear of the underwater vehicle including the ageing of the battery thereof.

In an advantageous embodiment, alternatively or additionally the usability indicator is a function of data of at least one travel time of the underwater vehicle which has taken place in at least one previous time period and within the operating time. During the travel time and/or whilst the underwater vehicle moves along, drives of the underwater vehicle and the battery of the underwater vehicle are subjected to particularly high levels of stress which affects the usability and/or the condition of the underwater vehicle.

In an advantageous embodiment, additionally or alternatively the usability indicator is a function of data of at least one resting time of the underwater vehicle which has taken place in at least one previous time period and/or a previous resting time outside the operating time. Even during the resting time, the general condition of the underwater vehicle can deteriorate, for example by ageing of the battery, by ageing of the rubber seals or corrosion on parts of the underwater vehicle.

In an advantageous embodiment, alternatively or additionally the usability indicator is a function of data of at least one environmental parameter detected during the operating time and/or travel time and/or resting time of the underwater vehicle and/or a currently detected environmental parameter. In particular, the ageing of the battery and possible corrosion are influenced by environmental parameters. Detected environmental parameters are a temperature and/or a pressure.

According to a first variant, the detected temperature is a temperature of the battery of the underwater vehicle. According to a second variant, the detected temperature is the temperature of the surrounding water and/or the ambient air around the underwater vehicle. According to a third variant, the detected temperature is the temperature of the air in the underwater vehicle. The variants can be combined with one another so that the usability indicator is optionally a function of a plurality of the temperatures. The pressure is, in particular, a detected surrounding water pressure and/or a detected ambient air pressure. Alternatively or additionally, the pressure encompasses a detected pressure in the interior of the underwater vehicle and/or in the battery of the underwater vehicle.

According to an advantageous embodiment, the device for operating the unmanned underwater vehicle comprises a use recommendation determining means for deriving the use recommendation from the usability indicator. The use recommendation is automatically determined according to predetermined rules, by using the usability indicator, so that the operating personnel of the underwater vehicle are subsequently provided with a decision aid when selecting an underwater vehicle suitable for a mission. Advantageously, in this case the invention differentiates between a recommended use in a non-object destruction mission without explosives and an object destruction mission, for example for the clearance of a mine. In various embodiments, the invention also differentiates whether the non-object destruction mission relates to an inspection mission and/or reconnaissance mission or a training mission for simulating an object destruction mission.

In various embodiments of the invention, the underwater vehicle is equipped for one respective mission with an interchangeable body provided therefor. For example, an interchangeable body comprising explosives is provided in an object destruction version for the object destruction mission. An interchangeable body in an inspection version without explosives and comprising a plurality of sensors is provided for the inspection mission. Finally for the training mission, an interchangeable body is provided in a training version which simulates the interchangeable body in the object destruction version. In various embodiments, therefore, the use recommendation determining means provide a recommendation for use of the underwater vehicle in combination with the object destruction version or in combination with the non-object destruction version, in particular the inspection version or training version, as a function of the usability indicator.

According to an advantageous embodiment, the device for operating the unmanned underwater vehicle comprises a display means for the visual display of the usability indicator or the use recommendation derived from the usability indicator. The usability indicator and/or the use recommendation is in this case coded, for example, as a visually represented color or as a digit or sequence of digits. The display means can be arranged on the underwater vehicle on an external control panel or on a further fixed or mobile device which comprises at least parts of the device according to the invention for operating the unmanned underwater vehicle. By means of the display means, operating personnel can rapidly identify the usability indicator and/or the use recommendation and thus be effectively assisted when selecting an underwater vehicle for a forthcoming mission.

According to an advantageous embodiment, the device for operating the unmanned underwater vehicle comprises storage means for storing the data determined for establishing the usability indicator and/or the usability indicator and/or the use recommendation. In various embodiments, the underwater vehicle comprises the storage means. Alternatively or additionally, the storage means are located outside the underwater vehicle, for example in the external control panel.

According to an advantageous embodiment, at least parts of the device for operating the unmanned underwater vehicle are arranged outside the unmanned underwater vehicle. As a result, data present externally can be taken into consideration for determining the usability indicator or the use recommendation. Moreover, the determination of the usability indicator or the use recommendation and/or the storage of the usability indicator or the use recommendation can take place, for example, on the central control panel.

Thus, according to an advantageous embodiment the device for operating the underwater vehicle comprises a data interface. The data interface is configured for transmitting data for determining the usability indicator and/or for transmitting the usability indicator and/or a use recommendation derived from the usability indicator via the data interface. In this case the data are either transmitted from the central control panel to the underwater vehicle and/or from the underwater vehicle to the central control panel and/or to a mobile display device for the visual display of the usability indicator and/or the use recommendation. The transmission can take place via a cable. Alternatively or additionally, however, it can take place via radio.

According to an advantageous embodiment, the data interface is configured for transmitting the charged state of at least one battery of the underwater vehicle from the underwater vehicle to a charging control device. Alternatively or additionally, an electrical cable which is provided for charging at least one battery of the underwater vehicle via the electrical cable, comprises the data interface. In any case, the data interface is implemented here by an otherwise present connection of the underwater vehicle to a fixed device. The fixed connection is generally provided continuously for monitoring and controlling the charged state of the battery of the underwater vehicle when stored. The charging control device is in various embodiments configured such that by repeated recharging of the battery, which in various embodiments comprises at least one lithium-ion rechargeable battery, the charging control device maintains the charged state of the battery in a range of between 60 and 70 percent of its full charging capacity. In such a charged state, chemical processes which could lead to the ageing of the battery are minimized. Moreover, it is possible to recharge the battery within about 10 to 15 minutes up to 100 percent or virtually 100 percent of its charging capacity and thus to make the underwater vehicle with the battery ready for use.

According to an advantageous embodiment, the device for operating the unmanned underwater vehicle comprises usability indicator resetting means for altering and/or adjusting the usability indicator as a function of a recorded servicing of the underwater vehicle. By means of servicing, the condition of the underwater vehicle is generally improved further so that the recently serviced underwater vehicle is suitable again for missions requiring a high degree of reliability, even when the underwater vehicle has already undertaken numerous missions and/or has completed a long service life.

The usability indicator resetting means in this case can be configured such that they reset the usability indicator to a value which differs from the value to which the usability indicator has been reset in response to previous servicing. After servicing has been carried out, the usability indicator is not reset to 0 or a fixed value but to a value which is calculated as a function of the data for determining the usability indicator and/or the usability indicator itself and/or a number of servicing operations carried out and/or missions carried out by means of the usability indicator resetting means.

According to an advantageous development of the invention, the device can be configured such that the device automatically blocks use of the underwater vehicle when the usability indicator associated with the underwater vehicle and/or the associated use recommendation reaches or exceeds a fixed value. The fixed value can be a function of the use provided and/or the mission for which the underwater vehicle is intended to be used. In this case, the usability indicator could be set by servicing of the underwater vehicle to a value below the threshold value and thus the underwater vehicle made ready for use by servicing for the forthcoming mission.

According to an advantageous embodiment, the determining means are configured for taking into account the usability indicators of a plurality of underwater vehicles when deriving the use recommendation. In this manner, assistance is provided to the operating personnel as to which of a plurality of available underwater vehicles should be selected for one respective mission. By way of example, an underwater vehicle, which in principle, is suitable for a forthcoming mission does not receive the use recommendation for carrying out the mission because at least one further underwater vehicle appears to be even better suited to this mission according to its usability indicator.

An underwater vehicle according to various embodiments of the invention has the determining means of the device according to the invention for operating the underwater vehicle and/or storage means for storing the usability indicator determined by means of the device according to the invention. As a result, it is possible to move the underwater vehicle, for example, to a different marine vessel and to be able to provide immediately the associated usability indicator, the usability indicator being either calculated or read from the storage means.

According to various embodiments of the invention, the underwater vehicle comprises further parts of the device for operating the underwater vehicle or the device or means for carrying out the method according to the invention for operating the underwater vehicle.

### DRAWINGS

Further embodiments are revealed from the claims and from exemplary embodiments described in more detail with reference to the drawings.

FIG. 1 shows an unmanned underwater vehicle as well as three interchangeable bodies which are able to be alternately fastened thereto, as well as a charging control device and a central control panel according to various embodiments of the invention.

FIG. 2 shows a schematic view of a device for operating the unmanned underwater vehicle of FIG. 1 according to various embodiments of the invention.

FIG. 3 shows a block diagram for illustrating a method for operating the unmanned underwater vehicle of FIG. 1 according to various embodiments of the invention.

### DETAILED DESCRIPTION

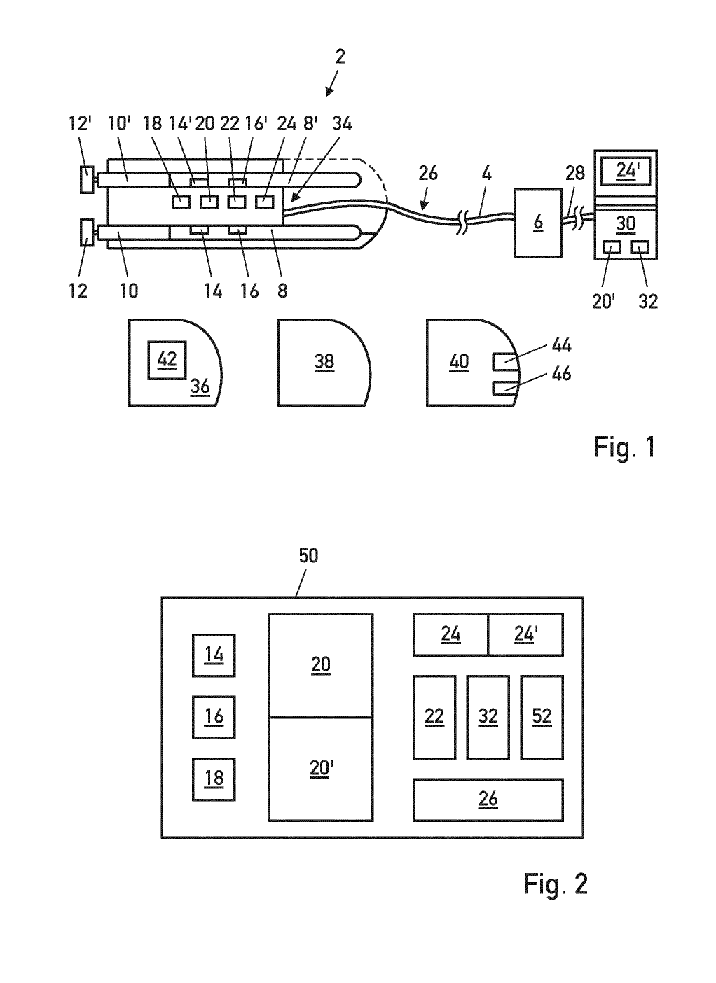

The FIG. 1 shows an unmanned underwater vehicle 2 which is mounted, for example, on-board a marine vessel and is connected by means of an electrical cable 4 to a charging control device 6. The electrical cable 4 can comprise a plurality of electrical conductors. The unmanned underwater vehicle 2 comprises batteries 8 and 8′ as well as further batteries which are arranged in a concealed manner and which are all configured as lithium-ion rechargeable batteries which can be charged up and the charged state thereof being monitored by means of the charging control device 6 via the electrical cable 4. If the charged state falls below a value of 60 percent of the charging capacity of the batteries 8 and 8′, the charging control device 6 initiates a recharging of the batteries 8 and 8′ via the electrical cable 4. By means of the charging control device 6 the charged state of the batteries 8 and 8′ is maintained between 60 percent and 70 percent of the charging capacity of the batteries 8 and 8′.

By means of the batteries 8 and 8′, at least electrical drive means 10 and 10′ and optionally further or all further electrical devices of the unmanned underwater vehicle 2 are supplied with electrical power. The electrical drive means 10 and 10′ are provided for driving propellers 12 and 12′ of the underwater vehicle 2.

A temperature sensor 14 and/or 14′ as well as a pressure sensor 16 and/or 16′ are arranged on the batteries 8 and 8′. The sensors 14, 14′, 16, 16′ monitor the temperature of the battery 8 and/or 8′ and the pressure in the battery 8 and/or 8′ and/or the pressure in the surroundings of the battery 8 and/or 8′ into which the battery 8 and/or 8′ might be degassed in the event of a defect, inside a pressure shell of the underwater vehicle 2.

Moreover, the unmanned underwater vehicle 2 comprises an operating hours meter and/or operating time meter 18 which detects the operating hours and/or the operating time of the underwater vehicle 2. Alternatively or additionally, a travel time meter and/or a resting time meter can also be provided.

Data from the operating time determined by means of the operating time meter 18 and data which has been determined by means of the temperature sensors 14 and 14′ as well as by means of the pressure sensors 16 and 16′, are stored in a storage means 20. Moreover, the unmanned underwater vehicle 2 comprises determining means 22 for determining a usability indicator, the determining means 22 using currently determined values therefor, for example by means of the temperature sensors 14 and 14′ as well as by means of the pressure sensors 16 and 16′, and/or data stored in the storage means 20. A usability indicator determined as a function of the values and/or data, is, for example, represented as a numerical value or color on a visual display means 24 of the underwater vehicle 2. For example, after a lengthy operating time or in the event of a raised temperature of the battery 8, a raised usability indicator is determined and a higher numerical value or a different color is emitted to and/or displayed on the visual display means 24.

At the same time a data interface 26 is provided by the electrical cable 4, via which the usability indicator is transmitted by the charging control device 6 and a further electrical cable 28 to a central control panel 30. The central control panel 30 has further storage means 20′ for storing the usability indicator as well as use recommendation determining means 32 which, based on the usability indicator, in particular by taking into account the usability indicators of further underwater vehicles and/or as a function of a planned mission, derive a use recommendation for the underwater vehicle 2 from the usability indicator. The use recommendation is also optionally stored in the storage means 20′ and displayed on a display means 24′ which is configured as a screen and/or display of the control panel 30.

The invention is not limited to the above-described arrangement of the operating time meter 18, the storage means 20 and 20′, the determining means 22, the visual display means 24 and 24′ and the use recommendation determining means 32, with regard to the arrangement on the unmanned underwater vehicle 2 and/or on the central control panel 30. For example, an operating time or resting time of the underwater vehicle 2 could also be determined at the central control panel 30 and transmitted via the data interface 26 to the underwater vehicle 2.

It is also possible initially to forward all data together to the central control panel 30, the data being used for determining the usability indicator, for example via the data interface 26, and to determine there the usability indicator as well as the use recommendation for the underwater vehicle 2. The determined usability indicator and/or the determined use recommendation can then in turn be transmitted via the data interface 26 to the underwater vehicle 2 and stored and/or visually displayed there. Alternatively or additionally, for displaying the usability indicator and/or the use recommendation to the underwater vehicle 2, a radio connection to a portable computer and/or electronic tablet can also be created in order to produce a display there of the usability indicator and/or the use recommendation.

The underwater vehicle 2 comprises receiver means 34 having fixing means, by means of which one of a plurality of interchangeable bodies 36, 38 and 40 can be removed from the underwater vehicle 2 and/or fixed to the underwater vehicle 2.

The underwater vehicle 2 can be equipped according to one respective intended use by means of the interchangeable bodies 36, 38, 40. The use determination, which is determined by means of the use recommendation determining means 32, generally requires that just one of the interchangeable bodies 36, 38 or 40 is fastened to the underwater vehicle 2 according to the use determination, when the underwater vehicle 2 is intended to carry out a mission according to the proposed use recommendation.

The interchangeable body 36 is an object destruction version which comprises explosives and is used for an object destruction mission, for example for clearing underwater mines. The interchangeable body 38 is a so-called dummy body and/or a training version which simulates the interchangeable body 36 so that the approach of the underwater vehicle 2 to a mine can be tested without explosives 42 being carried along with the underwater vehicle 2. Thus, the underwater vehicle 2 is able to be salvaged after the end of the mission.

The interchangeable body 40 is finally an inspection version which, for example, has a camera 44 as well as a sonar device 46 and optionally further or other sensors, not shown. Moreover, interchangeable bodies with actuators can be provided which, for example, permit repairs to be carried out to the base of a wind power installation located in the water or to repair an underwater pipeline.

FIG. 2 shows a block diagram of a device 50 according to the invention for operating the unmanned underwater vehicle, in particular the unmanned underwater vehicle 2 of the exemplary embodiment according to FIG. 1. The device 50 comprises a plurality of sensors and/or meters, namely the temperature sensor 14, the pressure sensor 16 and the operating time meter 18. Moreover, the device 50 comprises the storage means 20 and 20′, the display means 24 and 24′, the determining means 22 for determining the usability indicator, the use recommendation determining means 32, the data interface 26 as well as a usability indicator resetting means 52, not shown in FIG. 1, but optionally arranged on the underwater vehicle 2 or on the central control panel 30. By means of the usability indicator resetting means 52, the usability indicator can be reset, for example, to a value which is a function of the number of missions carried out and/or the number of servicing operations carried out.

At least the determining means 22, the usability indicator resetting means 22 and the use recommendation determining means comprise separate or common computing means and algorithms for calculating and/or resetting the usability indicator and/or for calculating the use recommendation.

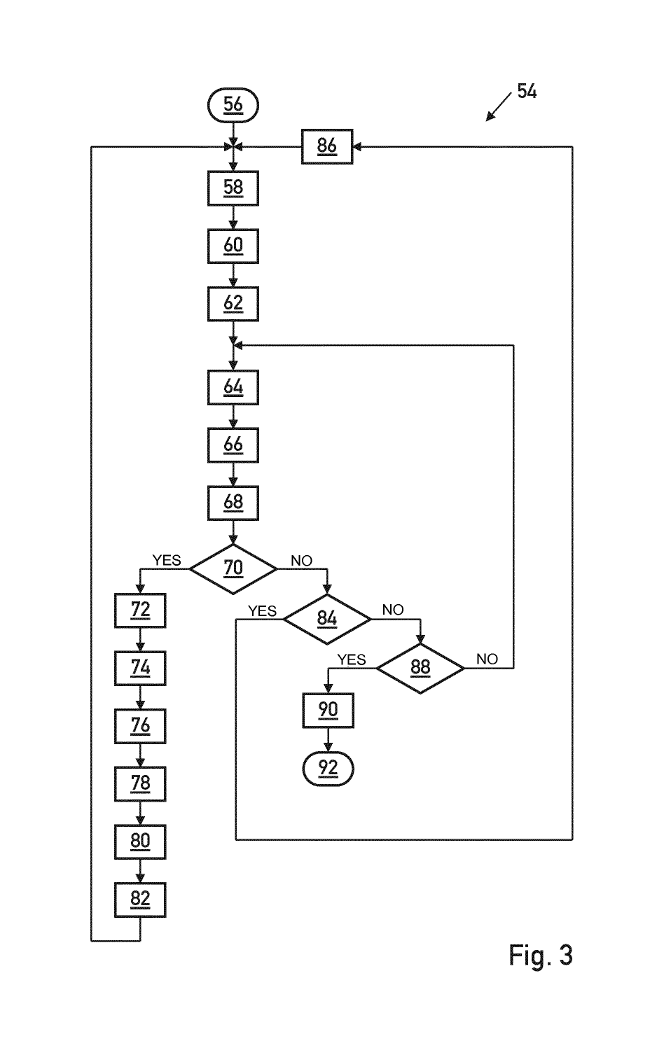

FIG. 3 is a flow chart illustrating a method 54 according to the invention for operating an unmanned underwater vehicle, in particular the underwater vehicle 2 according to FIG. 1, with reference to a block diagram.

The method 54 starts with a step 56, followed by determining a usability indicator in a step 58 and storing the usability indicator in a step 60. The usability indicator is subsequently transmitted in a step 62 via the data interface 26 to the control panel 30. Alternatively or additionally, a transmission is possible to a mobile device or to a display means for displaying the usability indicator on the underwater vehicle 2 or outside the underwater vehicle 2.

Step 62 is followed by a step 64 in which the underwater vehicle 2 is stored. In this case the battery 8, 8′ which is integrated fixedly in the underwater vehicle 2 is monitored, in particular with regard to its charged state, and recharged if required. Moreover, measures for carrying out maintenance and obtaining materials, such as full or partial charging and/or discharging of the battery 8, 8′ are regularly carried out in cycles. The charged state of the battery 8, 8′ is in this case kept at a value of approximately 60 to 70 percent of its charging capacity.

In a step 66, one respective use recommendation for the underwater vehicle 2 is determined from the usability indicator, in particular in combination with the usability indicators of further underwater vehicles. The use recommendation is subsequently visually displayed and/or visually represented or displayed in a different manner in a step 68. The underwater vehicle 2 being selected for a forthcoming mission can form part of the use recommendation. Optionally, however, the underwater vehicle 2 is also selected manually using the use recommendation 68. Whether the underwater vehicle 2 is selected for a forthcoming mission, as illustrated by a query 70. If the underwater vehicle 2 is accordingly selected, according to a step 72 the interchangeable body 36, 38 or 40 required for this mission is fastened to the underwater vehicle 2, provided it is not yet fastened thereto.

Subsequently, the mission is started in a step 74, the underwater vehicle 2 being let into the water and carrying out its mission in an autonomous or remotely controlled manner. During the mission, data are determined and/or detected according to a step 76, in particular by means of the operating time meter 18. Additionally, different environmental parameters such as temperature and pressure can be detected. The detection of data can optionally also be continued at least partially after the end of the mission. The data detected in step 76 are stored according to a step 78.

According to a step 80, the mission is subsequently terminated. If the mission is terminated by detonating the explosives 42 in the interchangeable body 36, the method is also terminated in step 80. Otherwise, the mission is generally terminated when the underwater vehicle 2 has returned to a salvaged position and from there is raised out of the water. The interchangeable body 38 and/or 40 is then potentially removed according to a step 82 but alternatively can also remain on the underwater vehicle 2. Now the method is continued in step 58 with storage, including trickle charging for the battery 8.

If the underwater vehicle 2 has not been selected in the query 70 for a forthcoming mission, this can be because the underwater vehicle 2 is currently not serviced and thus possibly has a usability indicator which is unsuitable for the mission. According to a query 84, it is possible to make the decision whether servicing is to be carried out. After a positive decision according to a step 86, the servicing of the underwater vehicle 2 is carried out and subsequently in step 58 the usability indicator is determined again. In particular, as a result of the maintenance the usability indicator is reset to a lower value but not to zero.

In particular, when the usability indicator reaches or exceeds a defined acceptance value, the underwater vehicle 2 is temporarily locked from use and first has to be subjected to servicing in order to lower the usability indicator again.

If the underwater vehicle 2 according to a query 88 has a usability indicator which also could no longer be reduced by potential servicing to an acceptable value, i.e. if the usability indicator is above the acceptance value and after possible servicing would also remain above this acceptance value, the end of the service life of the underwater vehicle 2 is reached so that the underwater vehicle 2 in a step 90 is permanently blocked from further use, whereby the method according to step 92 is terminated.

All the features cited in the above description and in the claims are able to be used individually and in any combination. The disclosure of the invention is therefore not limited to the described and/or claimed combinations of features. On the contrary, all combinations of features should be considered as disclosed.

What is claimed is:

1-15. (canceled)

16. A device for operating an unmanned underwater vehicle, said device comprising
a determining means for determining a usability indicator from which a use recommendation can be derived for use of the underwater vehicle in a future mission, the usability indicator derived as a function of data of at least one operating parameter of the underwater vehicle.

17. The device according to claim 16, wherein the usability indicator is derived as a function of:
data of at least one of an operating time and a travel time and a resting time of the underwater vehicle which has taken place in at least one previous time period; and
data of at least one of:
an environmental parameter detected during the at least one of the operating time and the travel time and the resting time of the underwater vehicle, and
the environmental parameter currently detected, wherein the environmental parameter comprises at least one of:
a temperature comprising at least one of a temperature of a battery of the underwater vehicle, a temperature of the surrounding water, a temperature of the air contained within the underwater vehicle, and a temperature located outside the underwater vehicle, and
a pressure comprising at least one of a pressure of the surrounding water pressure, and a pressure of the ambient air.

18. The device according to claim 17, wherein the use recommendation determining means for deriving the use recommendation from the usability indicator derives the use recommendation that comprises one of:
a recommendation for the use of the underwater vehicle in combination with an interchangeable body fixed to the underwater vehicle in an object destruction version comprising explosives,
a recommendation for use in combination with an interchangeable body fixed to the underwater vehicle in a non-object destruction version without explosives,
an inspection version comprising sensors for investigating the surroundings, and
a training version that simulates the object destruction version.

19. The device according to claim 18 further comprising a data interface for transmitting data for at least one of:
determining the usability indicator,
transmitting the usability indicator,
transmitting a use recommendation derived from the usability indicator via the data interface from at least one of:
a central control panel to the underwater vehicle,
the underwater vehicle to a central control panel, and
the underwater vehicle to a mobile display device for visual display of at least one of the usability indicator and the use recommendation.

20. The device according to claim 19, wherein the data interface is configured for transmitting a charged state of at least one battery of the underwater vehicle from the underwater vehicle to a charging control device,

21. The device according to claim 20 further comprising an electrical cable that comprises the data interface for charging at least one battery of the underwater vehicle via the electrical cable.

22. The device according to claim 20 further comprising a usability indicator resetting means for altering the usability indicator as a function of a recorded servicing of the underwater vehicle.

23. The device according claim 22, wherein the determining means are configured for taking into account the usability indicators of a plurality of underwater vehicles when deriving the use recommendation.

24. An underwater vehicle, said vehicle comprising at least one of:
a determining means for determining a usability indicator from which a use recommendation can be derived for use of the underwater vehicle in a future mission, the usability indicator derived as a function of data of at least one operating parameter of the underwater vehicle; and
a storage means for storing the usability indicator.

25. A method for operating an unmanned underwater vehicle, said method comprising:
determining a usability indicator as a function of data of at least one operating parameter of the underwater vehicle; and
deriving from the usability indicator a use recommendation for the use of the underwater vehicle in a future mission.

26. The method according to claim 25, wherein the usability indicator is determined as a function of:
data of at least one of an operating time and a travel time and a resting time of the underwater vehicle which has taken place in at least one previous time period; and
data of at least one of:
an environmental parameter detected during the at least one of the operating time and the travel time and the resting time of the underwater vehicle, and
the environmental parameter currently detected, wherein the environmental parameter comprises at least one of:
a temperature comprising at least one of a temperature of a battery of the underwater vehicle, a temperature of the surrounding water, a temperature of the air contained within the underwater vehicle, and a temperature located outside the underwater vehicle, and
a pressure comprising at least one of a pressure of the surrounding water pressure, and a pressure of the ambient air.

27. The method according to claim 26, wherein a use recommendation determining means derive the use recommendation from the usability indicator, the use recommendation is a function of the usability indicator being one of
a recommendation for the use of the underwater vehicle in combination with an interchangeable body fixed to the underwater vehicle in an object destruction version comprising explosives,
a recommendation for use in combination with an interchangeable body fixed to the underwater vehicle in a non-object destruction version without explosives,
an inspection version comprising sensors for investigating the surroundings, and
a training version simulating the object destruction version.

28. The method according to claim 27, wherein at least one of:
data for determining the usability indicator are transmitted via a data interface,
the usability indicator is transmitted via the data interface;
a use recommendation derived from the usability indicator are transmitted via the data interface from at least one of:
a central control panel to the underwater vehicle,
the underwater vehicle to a central control panel, and
the underwater vehicle to a mobile display device for visual display of at least one of the usability indicator and the use recommendation.

29. The method according to claim 28, wherein a charged state of at least one battery of the underwater vehicle is transmitted from the underwater vehicle to a charging control device via the data interface.

30. The method of claim 29 wherein at least one battery of the underwater vehicle is charged via an electrical cable that comprises the data interface.

31. The method according to claim 29, wherein a usability indicator resetting means alter the usability indicator as a function of a recorded servicing of the underwater vehicle.

32. The method according to claims 31, wherein the determining means take into account the usability indicators of a plurality of underwater vehicles when deriving the use recommendation.
